(19) United States
(12) Patent Application Publication
(10) Pub. No.: US 2025/0224313 A1
(43) Pub. Date: Jul. 10, 2025

(54) OPTIMISED ASSEMBLY FOR DETECTING VOLATILE COMPOUNDS IN A GASEOUS FLUID, COMPRISING A DETECTOR EQUIPPED WITH A SUCTION TUBE AND A VAPOUR-SAMPLING OPTIMISATION DEVICE

(71) Applicants: COMMISSARIAT A L'ENERGIE ATOMIQUE ET AUX ENERGIES ALTERNATIVES, Paris (FR); CNRS DÉLÉGATION CENTRE LIMOUSIN POITOU-CHARENTES (DR8), Orleans Cedex 2 (FR); UNIVERSITE DE TOURS, Tours Cedex 1 (FR)

(72) Inventors: Nicolas CLAVERIE, Monts (FR); Pierrick BUVAT, Monts (FR); Jérôme CASAS, Tours Cedex 1 (FR)

(73) Assignees: COMMISSARIAT A L'ENERGIE ATOMIQUE ET AUX ENERGIES ALTERNATIVES, Paris (FR); CNRS DÉLÉGATION CENTRE LIMOUSIN POITOU-CHARENTES (DR8), Orleans Cedex 2 (FR); UNIVERSITE DE TOURS, Tours Cedex 1 (FR)

(21) Appl. No.: 18/850,837

(22) PCT Filed: Mar. 29, 2023
(86) PCT No.: PCT/FR2023/050447

§ 371 Date: Sep. 25, 2024

(30) Foreign Application Priority Data
Mar. 30, 2022 (FR) 2202867

(51) Int. Cl. G01N 1/22; G01N 1/02; G01N 1/24

(52) U.S. Cl. CPC G01N 1/2273; G01N 1/24; G01N 2001/022; G01N 2001/242

(57) ABSTRACT

An assembly for detecting volatile compounds in a gaseous fluid includes a detector for detecting vapours, equipped with a suction tube, and a vapour-sampling optimisation device. This vapour-sampling optimisation device has an end piece with a body having a through-passage extending along an axis in a suction direction and configured to accept the suction tube. The device also has a fluidic network with an inlet in fluidic communication with at least one outlet. When the gaseous fluid is injected into the end piece via the inlet of the fluidic network, the network forms a jet of gaseous fluid which is ejected from the end piece on either side of the suction direction. Each jet forms an angle of 10° to 90° in absolute value with the axis of the suction direction, so that the jet ejected from the end piece moves away from the suction axis.

### TECHNICAL FIELD

The invention relates to the design and the production of an optimised assembly for detecting volatile compounds in a gaseous fluid, which comprises a detector for detecting vapours by suction equipped with a suction tube, and a vapour-sampling optimisation device. This device makes it possible to optimise the sampling of vapours for detecting and identifying volatile compounds in the air.

### PRIOR ART

Detecting volatile compounds (or vapours) in a gaseous medium (generally the air) is a major challenge in many fields and in certain particular fields, such as for example in the fields of detecting explosives and counter-terrorism; furthermore, it is essential to be able to detect the vapours of certain compounds in real time and with a good sensitivity.

Portable vapour detectors, in particular, are the most suitable for measurements in the field, in difficult environments, or in emergency situations.

One example of a portable vapour detector for detecting explosive compounds is described in document [1]. It can particularly be cited, as an example of such a detector, the detector from the brand T-REX™ by NBC-Sys.

This type of detector operates by sucking in the gaseous medium, which is in contact with the target to be analysed, using a sampling system, then by passing the collected vapours into a detection chamber provided with a plurality of micro-sensors.

Indeed, portable vapour detectors use, just like the T-REX™, detector, micro-sensors covered with specific materials that are sensitive to certain target compounds. These materials react with the compound vapours, such as explosives, which modifies some of their chemical features (mass, fluorescence, conductivity, etc.).

The sampling system is generally a simple tube and a suction pump. This sampling system is effective for measurements on contact with or at very short distances from the source, but is not optimised for suction at great distance.

Thus, in the portable detectors of the prior art, the system for sampling vapours by means of a simple tube and of a suction pump requires performing the sampling of vapours in contact with the target, which imposes the operator to take more risks forcing them to move close to the target. This also reduces the detection capabilities of this type of detector for finding a target present in a large volume of a gaseous medium, because this requires performing a sweeping of the entire volume of the gaseous medium in order to move close enough to the target and thus detect its presence.

By carrying out Particle Image Velocimetry (PIV) measurements, the Inventors noted that, with the T-REX™ detector (which, it is reminded, uses as sampling system a tube and a suction pump), the suction speed becomes negligible beyond 4 cm from the inlet opening of the tube.

Moreover, it is demonstrated that the suction through a tube is not very directional. Thus, on the PIV measurements, it is noted that the gaseous medium sucked in by the tube comes from all directions, including positions located below the inlet opening of the tube.

For a given suction rate, a hyperbolic decrease is observed in the speed of the gaseous medium sucked in depending on the distance to the inlet opening of the tube. This leads, for all sampling systems sampling the gaseous medium using a simple tube, to a suction range of a few centimetres at best, and to the sampling of the gaseous medium around the entire inlet opening of the tube and not only in contact with the target. This sampling of the surrounding gaseous medium dilutes the vapours captured and weakens the signal measured by the detector.

The olfaction strategies of the animal world are regularly studied and are a source of inspiration.

Thus, the authors of document [2] attempted to imitate the olfaction method of the dog that has asymmetrical-shaped nostrils for alternately breathing in and breathing out air close to the ground. This oscillating flow, coupled with the shape of the nostrils of the dog, creates an intermittent air flow that lifts the particles and guides them to the nose of the animal, which facilitates their detection. This operating principle has served as inspiration for the design of an explosive particle sampling system of the Ion Mobility Spectrometry (IMS) type for which the intensities of the detection signals are substantially increased, but remain low as soon as the detector is not in contact with the target.

The olfaction strategy implemented by the crayfish has also been the subject of many studies. The crayfish detects the odours in water thanks to its antennae. In order to improve the range of detection, the crayfish agitates special appendices in the shape of a palm to create rearward jets that carry the water in front of the animal, in the direction of the antennae. This operating principle has served as inspiration for the authors of document [3] for the design of a robot prototype projecting water sideways, which improves the detection capabilities of the robot. However, this prototype only works in water.

The sampling systems described above do not provide satisfactory answers to the need for improving the range for detecting vapours in a gaseous medium (generally the air) of sampling chemical detection devices (also called sampling devices).

In light of the above, there is a need to optimise the vapour-sampling capabilities of all types of portable vapour detectors and of the T-REX™ type in particular.

### DISCLOSURE OF THE INVENTION

In order to meet this need, the object of the invention is an optimised assembly (also called optimised nose) for detecting volatile compounds in a gaseous fluid, according to the features of claim 1.

In this optimised assembly according to the invention, the vapour-sampling optimisation device, intended to be used in conjunction with the detector for detecting vapours by suction equipped with a suction tube, for detecting volatile compounds in a gaseous fluid, comprises:
an end piece having a body provided with:
   a through-passage, extending in a suction direction and intended to accept the suction tube; and
   a fluidic network, which comprises an inlet and at least one outlet in fluidic communication with said inlet, the inlet and said at least one outlet between them defining a gaseous-fluid flow path; and
injection means, configured to inject the gaseous fluid into the fluidic network;

wherein the fluidic network is configured to, when the gaseous fluid is injected into the end piece via the inlet of the fluidic network, form at least one jet of gaseous fluid which is ejected from the end piece on either side of the suction direction, each jet forming an angle θ, in absolute value, with the suction direction, which is between 10° and 90°, inclusive.

Preferably, the injection means comprising a pump, the pump used to suck the gaseous fluid into the chamber and the pump used to inject the gaseous fluid into the end piece is one and the same pump.

Advantageously, the injection means include a pump, configured to suck in the gaseous fluid, and a hose, in fluidic communication with the pump, to connect the pump to the inlet of the end piece.

Thus, if the fluidic network only includes an outlet, it is fully understood that for there to be a jet of gaseous fluid that can be ejected on either side of the suction direction, the outlet will need to be configured for this. This is possible, for example, if it has the shape of a ring, which makes it possible to form a cone of gaseous fluid ejected around the suction direction (and therefore there is a jet on either side of the suction direction). Of course, the fluidic network may include a plurality of outlets (that is to say at least two) and in this case, there will be a plurality of jets (at least two) that will be formed.

Preferably, the angle θ is between 20° and 70°, inclusive.

Preferably, the surface of the straight section of the inlet is greater than or equal to the sum of the surfaces of the straight sections of each outlet, so as to obtain jets having an outflow greater than the inflow, i.e. an accelerated flow.

According to a preferred alternative embodiment, each jet forms the same angle θ, in absolute value, with the axis of the suction direction. In this alternative embodiment, each outlet is therefore disposed at equal distances from the opening of the through-passage, on either side of the suction direction. If there are a plurality of outlets, they may be dispersed around the suction direction, and be, for example, equidistant from one another.

According to one alternative embodiment, the fluidic network comprises at least two outlets, two outlets being positioned at the same height as one end of the through-passage, the fluidic network being configured in order that the jets coming out of these two outlets belong to the same plane, said plane also comprising the suction direction.

According to another alternative embodiment, the fluidic network comprises at least two outlets and includes a main channel that splits into at least two secondary channels, of which two secondary channels are symmetrical in relation to a plane that includes the through-passage. By way of example, the fluidic network may only include a main channel and two secondary channels.

According to one alternative embodiment, the secondary channels have a cross section that is constant.

According to another alternative embodiment, the secondary channels have a cross section that is reduced near the outlets.

The outlets may have an elliptical, preferably circular, shape.

According to another alternative embodiment, the outlet is defined by a hollowed surface between two concentric shapes and centred on the through-passage, the two shapes being ellipses, preferably circles, or polygons. By way of example, if the concentric shapes are circles, the outlet has the shape of a ring. The concentric shapes may also, for example, be squares or rectangles.

Another object of the invention is a vapour-sampling optimisation method for detecting volatile compounds in a gaseous fluid according to the features of claim 11. Thus, the method according to the invention comprises:
placing the suction tube in advance in the through-passage of the end piece;
forming at least one jet on either side of the suction direction by sucking the gaseous fluid into the chamber through the suction tube and, simultaneously, injecting the gaseous fluid into the inlet of the fluidic network, which causes an ejection of the gaseous fluid via said at least one outlet in the form of at least one jet.

Advantageously, the suction and the injection are performed using the same pump.

By forming jets of gaseous fluid around the suction direction, the range of suction is optimised in a preferred direction (which is that of the suction direction), which makes it possible to improve the detection capability of the vapour detector.

### BRIEF DESCRIPTION OF THE DRAWINGS

Other aspects, aims, advantages and features of the invention will become more apparent upon reading the following detailed description of preferred embodiments thereof, given by way of non-limiting example, and made with reference to the appended drawings, wherein:

FIG. 1 is a diagram of the concept of the invention, showing an end piece equipping a sampling tube of a detector for detecting vapours by suction.

FIGS. 2a to 2c are respectively side, top and front views of a first example of embodiment of an end piece according to the invention.

FIGS. 3a to 3c are respectively side, top and front views of a second example of embodiment of an end piece according to the invention.

FIGS. 4a to 4c are respectively side, top and front views of a third example of embodiment of an end piece according to the invention.

FIGS. 5a to 5c are respectively side, top and front views of a fourth example of embodiment of an end piece according to the invention.

FIG. 6 is a schematic representation, according to a perspective view, of a face of the end piece provided with a ring-shaped outlet, making it possible to form a cone of gaseous fluid around the suction direction.

FIGS. 7a and 7b are respectively a diagram of the PIV measurement bench according to a perspective side view and according to a top view.

FIG. 8 is a 3D model of an end piece according to the invention, superposed on an image obtained by PIV measurement.

FIGS. 9a and 9b are diagrams showing respectively an end piece according to the invention and the image obtained by PIV measurement in a measurement plane that corresponds to a horizontal measurement (FIG. 9a) and to a vertical measurement (FIG. 9b); in these two measurement planes, the coloured lines show the movements of the fluid (air flow) around the end piece.

FIG. 10 shows the movements of the fluid when the air is sucked in through a simple suction tube.

FIGS. 11a and 11b show the movements of the fluid when the air is sucked in through a suction tube equipped with an end piece according to the invention, but without the air jets being activated.

FIGS. 12a and 12b show the movements of the fluid when the air is sucked in through a suction tube equipped with an end piece according to the invention, with the air jets activated.

FIGS. 13a and 13b show the curve of the air speed depending on the distance to the inlet opening of the suction tube according to a horizontal measurement (FIG. 13a) and a vertical measurement (FIG. 13b) depending on whether the suction tube is simple (curve 2), with end piece without jets (curve 1) and with end piece with jets (curve 3).

### DETAILED DISCLOSURE OF PARTICULAR EMBODIMENTS

The optimised suction device according to the invention makes it possible, by using in conjunction with a conventional sampling system (namely, a simple tube and a suction pump) commonly used in existing vapour detectors, vapour sampling that is directional and with a greater range than with the sampling system alone.

This optimised suction device can be used in all detectors performing air sampling, because it makes it possible to increase the range and the precision of the air suction, without changing the suction rate.

This optimised suction device can in particular be used in portable toxic product or explosive detectors that operate by sampling the ambient air by means of a tube. For such detectors, the device according to the invention indeed makes it possible to increase the range and the selectivity of the sampling of the ambient air, which guarantees a greater safety of the operator of the detector by enabling them to keep a greater distance during samplings, but also to limit the disturbances of the target to be analysed.

The principle of the system according to the invention is the generation of air jets, in addition to the conventional suction through a tube. These air jets, by moving away from the suction axis of the tube, create an additional suction that brings the vapours back within range of the inlet opening of the suction tube, where they are subsequently sucked in. In addition, if a plane containing the suction axis and at least two jets is considered, these two air jets will block the suction of the air in directions other than in the suction axis, which makes a more targeted suction possible. This is why a configuration with a multitude of jets coming out of outlets placed circularly around the through-passage, with the same angle θ, in absolute value, in relation to the suction axis, is a particularly advantageous configuration. Preferably, a ring-shaped outlet, for example, makes it possible to generate a cone of air expelled around the suction axis, and therefore a substantially unidirectional suction, which is particularly advantageous.

Fairly simply, these jets are generated by injecting the air, by means of a suction pump, into a suitable end piece that is fastened on the suction tube of the vapour detector, the configuration of the end piece being optimised to define improved suction profiles. Preferably, in the interest of portability and easy adaptation to existing vapour detectors (and in particular to the T-REX™ detector for which the invention has been developed), the internal pump of the detector (used to suck the air into the detector) is used to re-inject the air into the end piece.

The operating principle of such an assembly is illustrated in FIG. 1.

FIG. 1 has a detector 1 for detecting vapours by suction (for example the T-REX™ detector), which is equipped with a suction tube 2 that makes it possible to suck air into a chamber (not shown) of the detector by means of a pump 8. An end piece 3 is disposed on one end of the tube 2. A hose 7 is disposed between an air outlet 6 of the pump 8 of the detector and an inlet 12, made in the body of the end piece 3. Thus, air is sucked in by the pump of the detector into the chamber through the suction tube 2, and the hose 7 redirects the suction air flow, coming out of the detector through the air outlet 6, into the inlet 12 of the end piece where a fluidic network separates the flow into a plurality of flows and accelerates it before releasing it in the form of air jets 4 expelled on either side of the suction tube 2. The path of the air entering the tube and flowing into the hose is illustrated by wide arrows 5.

The end piece of the device according to the invention includes a body 15, preferably having a parallelepiped shape, with possibly at least two truncated angles. This parallelepiped shape is practical, but the body may have other shapes.

The end piece is provided to be inserted on the suction tube of the detector; the body of the end piece therefore includes a through-passage 10, intended to accept the suction tube, which will suck in the vapours. The through-passage is a straight (rectilinear) pipe. The through-passage 10 is preferably a cylinder-shape tube of which the inside diameter is slightly greater than the outside diameter of the suction tube 2.

The end piece can be positioned at the end of the tube, so that the inlet opening of the tube is flush with the body of the end piece. The end piece can also be positioned in such a way that the inlet opening of the tube protrudes from the body of the end piece.

The body of the end piece also includes a fluidic network 11, the network comprising an inlet 12 (for the air intake from a suction pump, preferably the pump of the detector) and a plurality of outlets 13 that are in fluidic communication with the inlet 12 (these outlets 13 making it possible to output air expelled at high speed). The fluidic network 11 may come in many configurations.

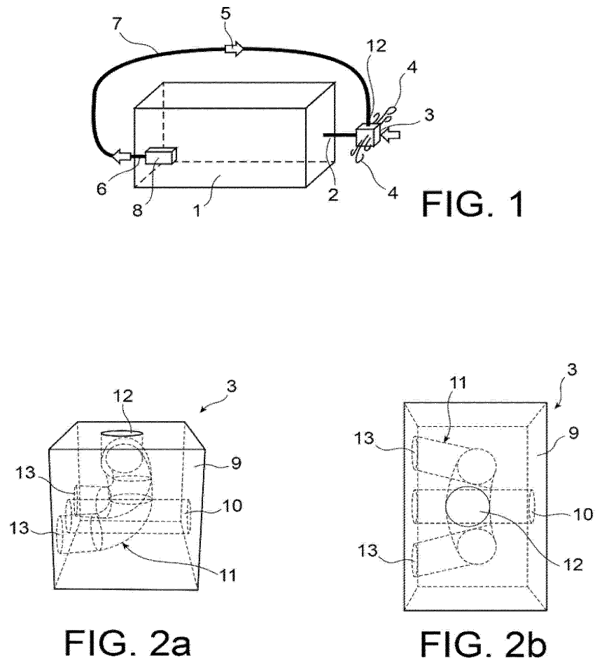

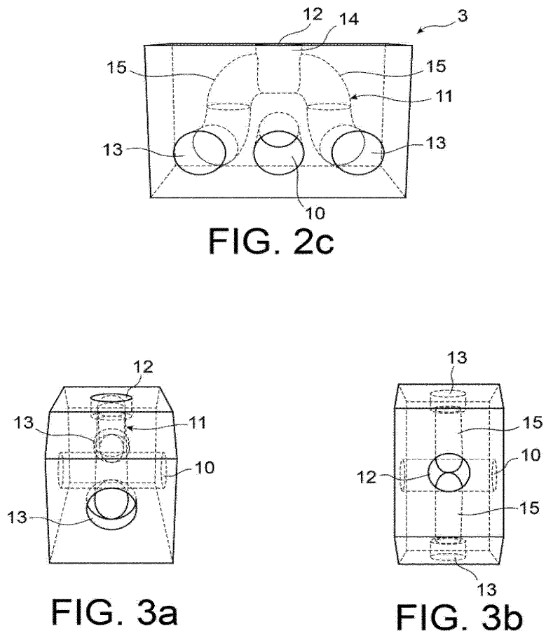

The inlet 12 (through which the flow coming out of the suction pump is brought into the fluidic network) is preferably located on the upper face (as illustrated in the following FIGS. 2 to 5) or lower face of the body 9 of the end piece in such a way as to not disturb the flows located in the front face, but may just as easily be located on another face of the body.

If the fluidic network includes more than two outlets, the air outlets 13 may all be geometrical shapes (in particular, disk, ellipse, etc.).

If the fluidic network includes a single outlet 13, the outlet must be a geometrical shape making it possible to form a jet coming out on either side of the suction direction. Preferably, this geometrical shape is a ring centred on the suction direction, as illustrated in FIG. 6, making it possible to form a cone 28 around the suction direction 17.

FIGS. 2a, 2b, 2c illustrate an example of possible configuration of an end piece with two jets.

In these FIGS. 2a-2c, the end piece includes a through-passage 10, and a fluidic network 11 formed by a main channel 14 that splits into two secondary channels 15 that are symmetrical in relation to a plane comprising the through-passage and the main channel. The air flow enters into the body of the end piece (and in the main channel 14 of the fluidic network) via the inlet 12 and comes out in the form of two air jets via the outlets 13. It can be seen by transparency, in these FIGS. 2a-2c, the way in which the incoming air flow is separated into two to form two air jets.

In this example, the body 9 of the end piece is in the shape of a parallelepiped, the through-passage 10 passes through two opposite lateral faces (here the front and rear faces), the air flow enters via the inlet 12 that is present on the upper face of the body, and the outlets 13 of the secondary channels open onto the front face, on either side of the through-passage 10. Furthermore, the suction axis of the through-passage 10 is located at the same height (on the same plane) as the outlets 13, and the outlets 13 are at equal distances from the axis of the through-passage. This makes it possible to improve the suction in the plane defined by the two outlets and the through-passage.

The end piece according to the invention may obviously have other configurations with two jets, or other configurations with more than two jets, it being important to confine the suction air on at least two sides of the suction tube, preferably symmetrically. For example, with two jets symmetrically ejected on either side of the suction direction, it is possible to confine the suction air in the suction direction. According to another example, it is also possible to have a configuration with at least three secondary channels of which the outlets are equidistant from one another and disposed at equal distance from the suction direction (at the three apices of an equilateral triangle with the through-passage located at the centre of the triangle). Preferably, it is sought to increase the number of jets in such a way as to tend towards a multitude of jets of which the assembly defines an air cone projected around the suction direction. This projected air cone may be a volume of pyramidal or conical shape with a truncated apex, having in the straight section a ring, round elliptical, square, rectangular, etc., shape and of which the sides move apart as it moves away from the apex.

The end piece particularly includes all of the configurations that make it possible to vary the outlet angles of the air jets in relation to the suction direction of the tube (inlet axis of the air sucked in by the tube).

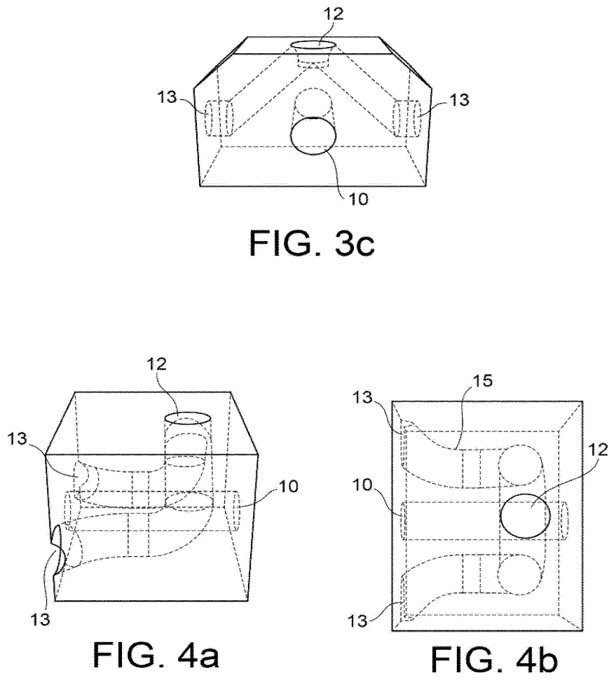

Another example of possible configuration with two jets is illustrated in FIGS. 3a to 3c. In this example, the air flow enters into a main channel and is split between two secondary channels that open onto the sides of the body of the end piece, perpendicular to the axis of the through-passage 10 (which will be the suction axis of the suction tube, when the latter will be inserted into the through-passage) and at the same height.

In this example, the two air jets formed will be located perpendicular to the suction axis of the suction tube.

It should be noted that in the example of configuration illustrated in FIGS. 3a-3c, the inlet and the two outlets have a circular shape, but the channels leading from the inlet to each outlet have a portion having an elliptical straight section; the diameter of the circular shape is also shown equal to the largest dimension of the ellipse.

The dimensions of the various openings formed in the end piece (inlet 12 and outlets 13), as well as the diameter of the channels of the fluidic network may be 6 mm, i.e. the outside diameter of the suction tube used in the T-REX™ detector.

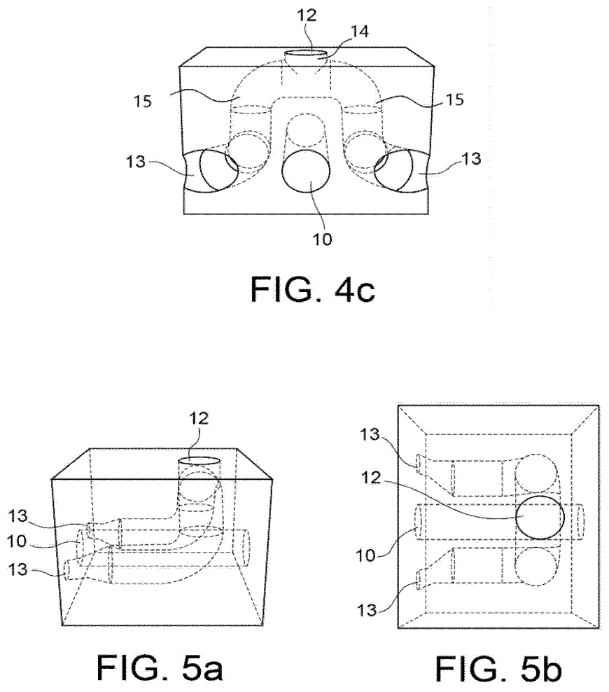

Another example of possible configuration is illustrated in FIGS. 4a-4c. Here, the outlets 13 of the two secondary channels 15 open onto the front face of the body of the end piece, at the same height as the through-passage 10, and with an angle of 45 degrees in relation to the axis of the through-passage 10.

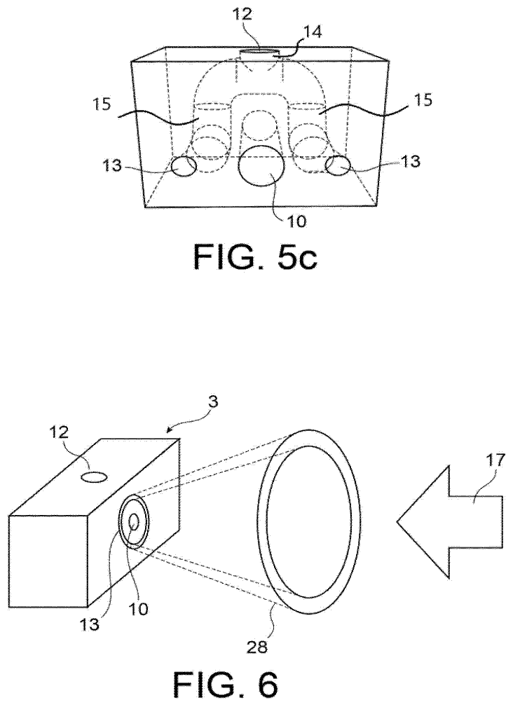

A last example of possible configuration is illustrated in FIGS. 5a-5c. As in the previous examples, the body of the end piece is equipped with a through-passage 10 for the passage of the suction tube for the vapours to be detected, with a circular opening (inlet 12) in the upper face of the body, for the arrival of air to be re-injected, which opens onto a main channel 14 that splits into two symmetrical secondary channels 15, these secondary channels having a final portion of which the diameter shrinks to open, in the front face of the body 9 of the end piece, via the outlets 13. This final portion also has an angle of 45 degrees in relation to the axis of the through-passage. In this example, the diameter of the outlets has been reduced to 3 mm, compared to 6 mm in the previous examples in order to double the air output speed. The two air jets, in this example, therefore have a greater speed than in the previous examples.

In the examples above, the openings of the outlets 13 have a circular shape, but they may absolutely have another shape, for example an elliptical, square, rectangular, etc., shape.

It is specified that the 3D structure of the end piece (body, through-passage and fluidic network) may be made of any type of materials that do not interfere with the targets to be detected. The choice of the material will therefore be suitable for the application. For example, for a detection of pyrotechnical compositions, the end piece may be made of polylactic acid (PLA). Moreover, the 3D structure may be of very complex shape, particularly its inner part with the fluidic network, but will be easy to produce by 3D printing.

Once the end piece has been placed on the suction tube of a detector for detecting vapours by suction, for example a T-REX™ detector, the assembly thus formed makes it possible to obtain a nose that is even more efficient than the detector alone.

In order to illustrate the performance of the optimised device according to the invention, an end piece was fastened on a suction tube of the T-REX™ detector and the suction flows generated by this nose were measured by the PIV method.

The PIV measurement consisted in observing the movements of Di-Ethyl-Hexyl-Sebacat (DEHS) oil particles in suspension in the air contained in an enclosed space wherein the nose to be studied was placed.

The T-REX™ detector 1 was therefore placed in a sealed tank 20 with transparent walls of the aquarium type, so that the droplets used to measure air flows do not escape or that the external air movements do not disturb the measurements. The T-REX™ detector was placed in such a way that the end of the suction tube 2 is located at more than 12 cm from each wall of the tank to limit the edge effects.

The mist of DEHS droplets is dispersed and the air flow stabilised (the resulting gaseous fluid is designated by the reference 27).

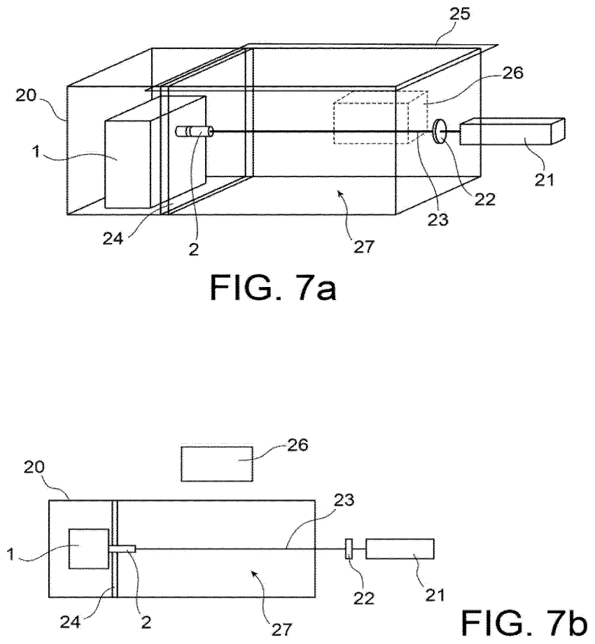

A laser 21 (here the continuous wave laser of power 2 W from LaVision with reference VL-2 W cw) and a divergent cylindrical lens 22 of focus-10 mm were placed outside of the tank 20 in the axis of the suction tube 2 of the detector, in order to create a laser sheet illuminating the droplets in suspension. The laser beam is designated by the reference 23. A high-speed video camera 26 (here the Phantom v9.1) was placed perpendicular to the installation (outside of the tank) to film the movement of the particles illuminated by the laser. FIGS. 7a and 7b respectively show perspective schematic views and top view of this measurement bench.

A wall 24 (for example a foam plate) is used to separate the tank into two parts. This makes it possible to isolate the detector and thus make it possible to establish air flows without parasitic disturbances induced by thermal effects, for example related to the heating of the faces illuminated by the laser. The detector will be placed in a first part of the tank and the suction tube will be inserted into an opening of the wall 24 to open into the second part of the tank; it is in this second part that the PIV measurements will be performed. A cover 25 (for example made glass) is positioned on the second part of the tank in order to confine the medium.

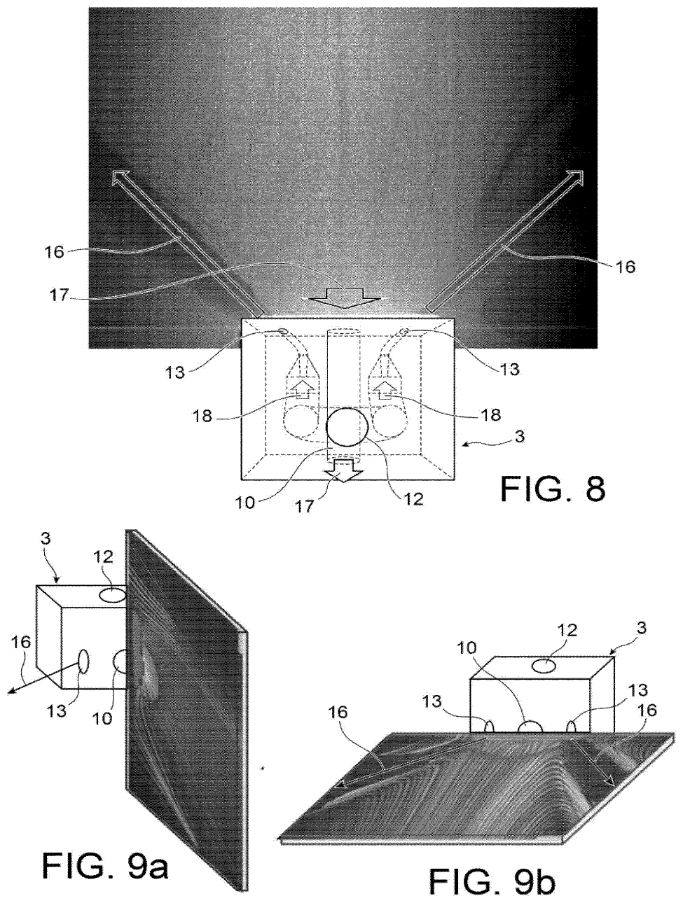

FIG. 8 shows a 3D model of an end piece according to the invention, superposed with an image of a PIV measurement (“PIV image” shortcut below) obtained using the video camera. The direction of the suction air tube (oriented according to the suction direction) is shown by two large arrows 17. This air is sucked into the T-REX™ detector, which is not shown. The direction of the air re-injected into the end piece and flowing in the secondary channels is also shown, by small wide arrows 18; the two air jets expelled from the end piece 3 are also shown, by long narrow arrows 16.

In the PIV image, the dark areas are characteristic of an absence of droplets. Thus, the side jets produced by the nose are observed on the PIV image.

In order to illustrate the advantageous contribution of the optimised suction device according to the invention equipping the T-REX™ detector, the movement of the air upstream of the suction tube was measured according to three scenarios:
for a single suction tube (without end piece), showing the actual state of the detector;
for a tube equipped with an end piece according to the invention, but of which the jets have not been activated (the air coming out of the pump is not re-injected into the end piece); and
for a tube equipped with an end piece according to the invention with the air jets activated.

The suction rate has been kept the same in the three scenarios.

Furthermore, in order to guarantee a good measurement of the air flows upstream of the suction tube of the detector, the flows were measured according to two perpendicular planes as shown in FIGS. 9a and 9b. Thus, this gives a measurement plane 19 obtained by performing a horizontal measurement (FIG. 9a), the video camera being placed laterally in relation to the tank, as illustrated in FIGS. 7a and 7b, and a measurement plane 19 obtained by performing a vertical measurement (FIG. 9b), the video camera being placed above the tank. These FIGS. 9a and 9b show the end piece, the PIV image obtained, as well as the direction of the jets. The end piece shown in these FIGS. 9a and 9b includes two outlets having an elliptical shape.

The results of the PIV measurements show that the suction air speed is significantly increased along the two planes when the end piece is positioned on the suction tube and when it emits jets, compared to the case where the suction tube does not include an end piece or when the end piece is inactive (does not emit jets).

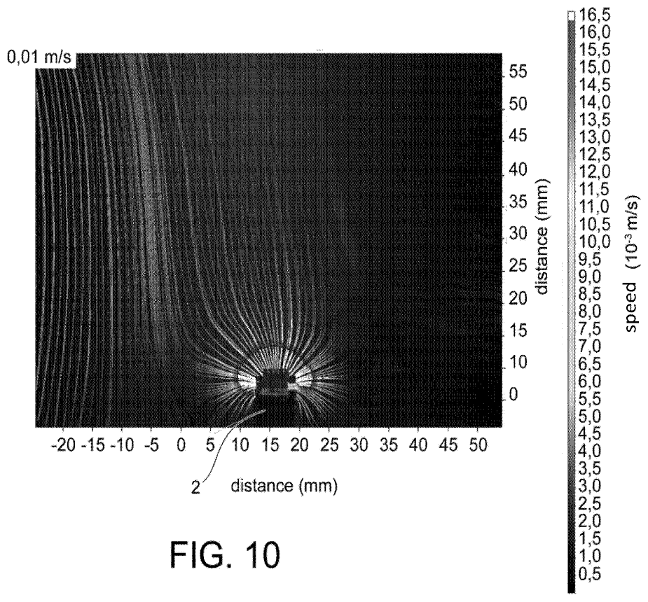

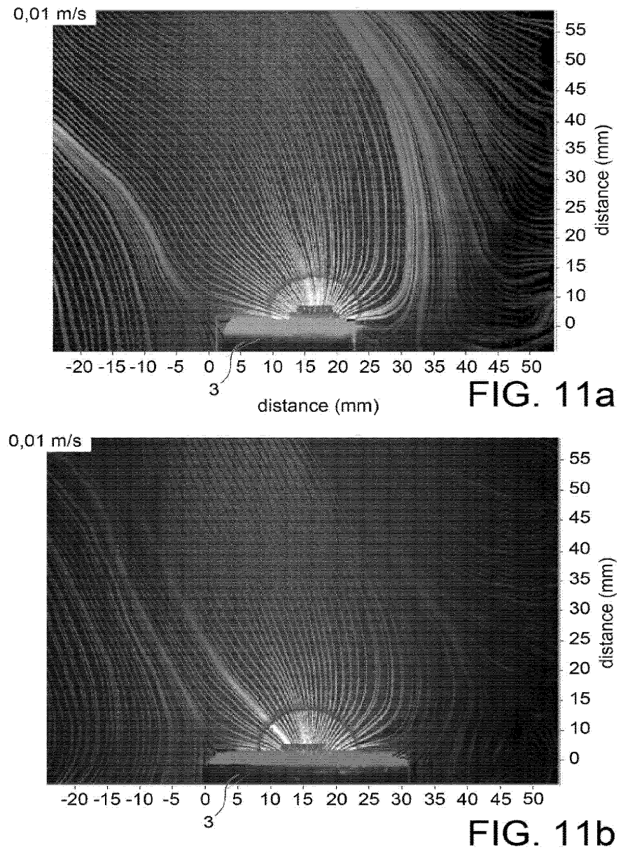

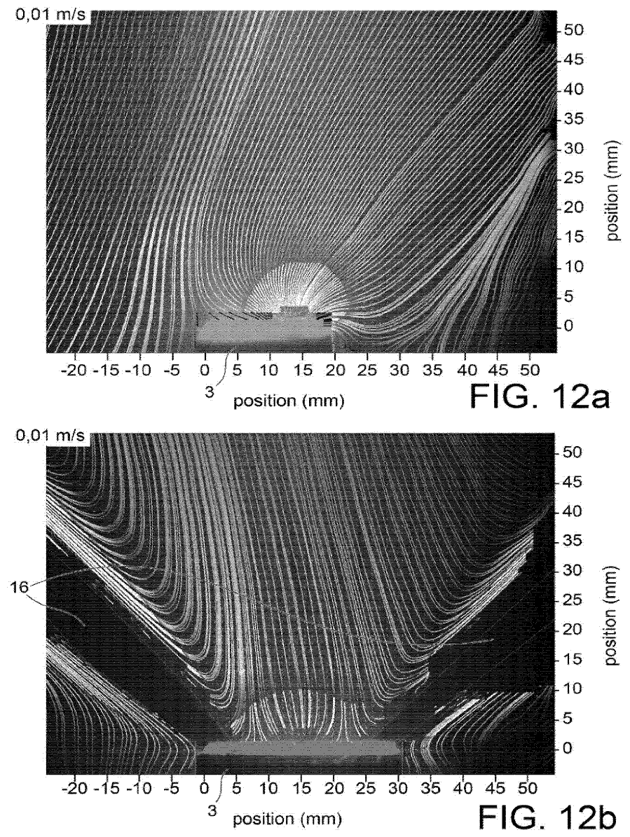

FIGS. 10 to 12 show the flow lines (paths taken by the fluid over time) and the speed of the fluid for a simple tube (FIG. 10) and for a tube equipped with the end piece according to the invention without jets (FIGS. 11a and 11b) and with jets (FIGS. 12a and 12b), according to each measurement plane (horizontal measurement (FIGS. 11a and 12a); vertical measurement (FIGS. 11b and 12b)).

The speed scale (scale with the colour gradations displayed in FIG. 10) is the same for all of the FIGS. 10 to 12 and is 0.01 m/s.

It is observed, in FIG. 10, that the tube 2 sucks in the air in all directions (the lines of the flows close to the inlet opening of the suction tube go in all direction, including rearwards).

In FIGS. 11a and 11b, it is observed that the end piece, without activated air jet, even so prevents the suction tube from sucking in rearwards.

In FIGS. 12a and 12b, it is observed that the confinement of the suction flow, with an equal suction rate in relation to FIGS. 10 and 11, makes a higher speed of the suction flow possible, and guarantees a directional suction making it possible to only sample the targeted area. In addition, the high speed of the jets coming out of the end piece creates a global air movement towards the detector, which adds to the suction caused by the suction tube. In fact, the suction of the end piece and the directionality of the suction (created by the air jets) are superposed to make better stirring possible (which results in the speed of the flows) in the area to be sampled.

Finally, the measurement of the variation in speed of the air flow in the measurement axis of the detector (i.e. the suction axis of the tube), for each scenario, makes it possible to further illustrate the benefit of the optimisation device according to the invention.

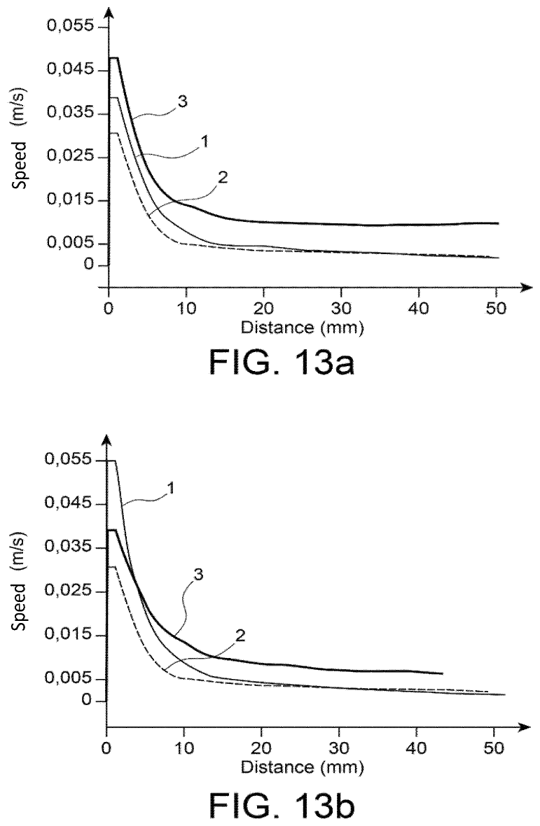

FIGS. 13a and 13b make it possible to visualize the decrease in speed of the fluid sucked in depending on the distance to the inlet opening of the suction tube.

It is observed, according to the two measurement planes (horizontal measurement (FIG. 13a) and vertical measurement (FIG. 13b)), that the suction speed is the highest near the suction end piece (short distance), where the measurement saturates (a speed plateau, of which the value is not significant, is observed), then it gradually decreases with the distance.

If the end piece without activation of the jets (curve 1) only has a low impact on the suction speed at a distance from the end piece in relation to a single tube (curve 2), the end piece with activation of the jets (curve 3) makes it possible to significantly reduce the decrease in speed with the distance and thus to suck in the air more effectively at a greater distance from the detector. Indeed, compared to a single tube, the end piece with activation of the jets makes it possible to increase the suction speed, at 40 mm from the inlet opening of the suction tube equipped with the end piece, by 160% for the vertical measurement, and by 260% for the horizontal measurement. By comparison, these suction speeds are obtained respectively at 7.6 mm and at 6 mm from the inlet opening of the suction tube for a single tube.

Therefore, it can be expected that the detection range of a detector is quadrupled when it is equipped with the optimisation device according to the invention.

### REFERENCES

[1] EP 2 673 617 B1
[2] Staymates M. E. et al., “Biomimetic Sniffing Improves the Detection Performance of a 3D Printed Nose of a Dog and a Commercial Trace Vapor Detector”, Scientific3 Reports 6, article number: 36876 (2016)
[3] Ohashi M. et al., “Crayfish Robot That Generates Flow Field to Enhance Chemical Reception”, Journal of Sensor Technology, 02 (04), pages 185-195 (2012)

1. An assembly for detecting volatile compounds in a gaseous fluid, the assembly comprising:
a detector for detecting vapours by suction, equipped with a suction tube; and
a vapour-sampling optimisation device, configured to be used in conjunction with the detector for detecting vapours by suction, the vapour-sampling optimisation device comprising:
an end piece having a body provided with:
a through-passage, extending along an axis in a suction direction and configured to accept the suction tube; and
a fluidic network, which comprises an inlet and at least one outlet in fluidic communication with the inlet, the inlet and the at least one outlet between them defining a gaseous-fluid flow path; and
injection means, configured to inject the gaseous fluid into the fluidic network;
wherein the fluidic network is configured to, when the gaseous fluid is injected into the end piece via the inlet of the fluidic network, form at least one jet of gaseous fluid which is ejected from the end piece on either side of the suction direction, each jet forming an angle θ, in absolute value, of 10° to 90° with the axis of the suction direction, such that the jet of gaseous fluid ejected from the end piece moves away from the suction axis,
wherein the detector further comprises a chamber and a pump, configured to suck the gaseous fluid into the chamber through the suction tube, and
wherein when the assembly is operating, the end piece is positioned on the suction tube, and the gaseous fluid is simultaneously sucked into the chamber, by the pump, through the suction tube and injected into the inlet of the end piece by the injection means.

2. The assembly of claim 1, wherein the injection means comprises a pump,
wherein the pump used for sucking the gaseous fluid into the chamber and the pump used to inject the gaseous fluid into the end piece is one and the same pump.

3. The assembly of claim 2, wherein the injection means further comprises a hose, in fluidic communication with the pump, to connect the pump to the inlet of the end piece.

4. The assembly of claim 1, wherein each jet forms the same angle θ, in absolute value, with the axis of the suction direction.

5. The assembly of claim 1, wherein the fluidic network comprises at least two outlets, the at least two outlets being positioned at the same height as one end of the through-passage, the fluidic network being configured so that the jets coming out of these two outlets belong to the same plane, the plane also comprising the suction direction.

6. The assembly of claim 1, wherein the fluidic network comprises at least two outlets and a main channel that splits into at least two secondary channels, of which the at least two secondary channels are symmetrical in relation to a plane that includes the through-passage.

7. The assembly of claim 6, wherein the secondary channels have a cross section that is constant.

8. The assembly of claim 6, wherein the secondary channels have a cross section that reduces near the outlets.

9. The assembly of claim 1, wherein the outlets have an elliptical shape.

10. The assembly of claim 1, wherein the outlet is defined by a hollowed surface between two concentric shapes and centred on the through-passage, the two shapes being ellipses or polygons.

11. A vapour-sampling optimisation method for detecting volatile compounds in a gaseous fluid using the assembly of claim 1, the method comprising:
placing the suction tube in advance in the through-passage of the end piece; and
forming at least one jet on either side of the suction direction by sucking the gaseous fluid into the chamber through the suction tube and, simultaneously, injecting the gaseous fluid into the inlet of the fluidic network, which causes an ejection of the gaseous fluid via the at least one outlet in the form of at least one jet.

12. The method of claim 11, wherein the suction and the injection are performed using one and the same pump.
